(19) United States
(12) Patent Application Publication
(10) Pub. No.: US 2019/0236633 A1
(43) Pub. Date: Aug. 1, 2019

(54) Raffle Method of Purchasing a Product of Service

(71) Applicant: Dionisis Cooks, Fairview, UT (US)

(72) Inventor: Dionisis Cooks, Fairview, UT (US)

(21) Appl. No.: 16/264,646

(22) Filed: Jan. 31, 2019

Related U.S. Application Data
(60) Provisional application No. 62/624,469, filed on Jan. 31, 2018.

(51) Int. Cl. G06Q 30/02; G06Q 30/08; G06Q 20/32

(52) U.S. Cl. CPC G06Q 30/0212; G06Q 20/322; G06Q 30/08

(57) ABSTRACT

A method of raffle transaction has been developed comprising an electronic server receiving data for a transaction event and requiring a seller, through a cloud network, to add a transaction item, a number of raffle slots, a time period, and a price. The transaction item is listed through a network where a buyer purchases one or more of the number of raffle slots through an electronic device. The purchases of the number of raffle slots sold during the time period are tracked, and any remaining raffle slots at the end of the time period are awarded to the seller. A winning raffle slot is selected randomly, and the transaction item is awarded to the buyer of the winning raffle slot. The seller distributes the transaction item through the raffle transaction using the transaction event.

### RELATED APPLICATIONS

This application claims priority to U.S. Provisional Patent No. 62/624,469 filed on Jan. 31, 2018, the disclosure of which is hereby incorporated by express reference thereto.

### FIELD OF THE INVENTION

The present invention discloses a method of purchasing or selling a product or service.

### BACKGROUND

Selling items online has been a trend for at least a decade and is only growing.

### SUMMARY

A method of raffle transaction has been developed comprising an electronic server receiving data for a transaction event and requiring a seller, through a cloud network, to add a transaction item, a number of raffle slots, a time period, and a price. The transaction item is listed through a network where a buyer purchases one or more of the number of raffle slots through an electronic device. The purchases of the number of raffle slots sold during the time period are tracked, and any remaining raffle slots at the end of the time period are awarded to the seller. A winning raffle slot is selected randomly, and the transaction item is awarded to the buyer of the winning raffle slot. The seller distributes the transaction item through the raffle transaction using the transaction event.

A system of raffle transaction has been developed along with the above method comprising of an electronic server that collects data for a transaction event, a cloud network connecting the electronic server and the data for the transaction event to a seller through a seller's electronic device, and a buyer through a buyer's electronic device. The system comprises of a non-transitory computer program product programmed to use the electronic server to receive data for the transaction event. A seller is required, through the cloud network, to add a transaction item, a number of raffle slots, a time period, and a price. The transaction item is listed through a network and a buyer purchases one or more of the number of raffle slots through an electronic device. The purchases of the number of raffle slots sold during the time period are tracked, and any remaining raffle slots at the end of the time period are awarded to the seller. A winning raffle slot is selected randomly, and the transaction item is awarded to the buyer of the winning raffle slot. The seller distributes the transaction item through the raffle transaction using the transaction event.

Purchasing of a raffle slot may be done through a bidding process or direct purchasing. The seller may designate a number or percentage of the number of raffle slots to be purchased by the bidding process, the seller may choose a hybrid transaction by using both the bidding process and direct purchasing. The seller may choose a number of raffle slots to be sold and a set price for the transaction item and the price of the raffle slots may be determined by the set price of the transaction item divided by the number of raffle slots to be sold. For bidding process raffle slots, the seller may choose a starting price for the raffle slots. The transaction event may be set for a geographical area chosen by the seller.

A buyer of one or more of the number of raffle slots may become a reseller by selecting the resale option. The resale may occur within the original transaction event and may continue until the time period expires. The reseller may resell the one or more of the number of raffle slots for a higher price by way of direct purchasing, or by the bidding process.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a depiction of a raffle transaction system in accordance with an embodiment of the invention;

FIG. 2 is a flow diagram of a raffle transaction event in accordance with an embodiment of the invention;

FIG. 3 shows a flow diagram of a buyer in accordance with an embodiment of the invention;

FIG. 4 shows a flow diagram of a setup process of a transaction event in accordance with an embodiment of the invention;

FIG. 5 shows a depiction of a transaction event in accordance with an embodiment of the invention;

FIG. 6 shows an example of an electronic device screen shot in accordance with an embodiment of the invention;

FIG. 7 shows an example of an electronic device screen shot in accordance with an embodiment of the invention;

FIG. 8 shows an example of an electronic device screen shot in accordance with an embodiment of the invention; and

FIG. 9 shows an example of an electronic device screen shot in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings.

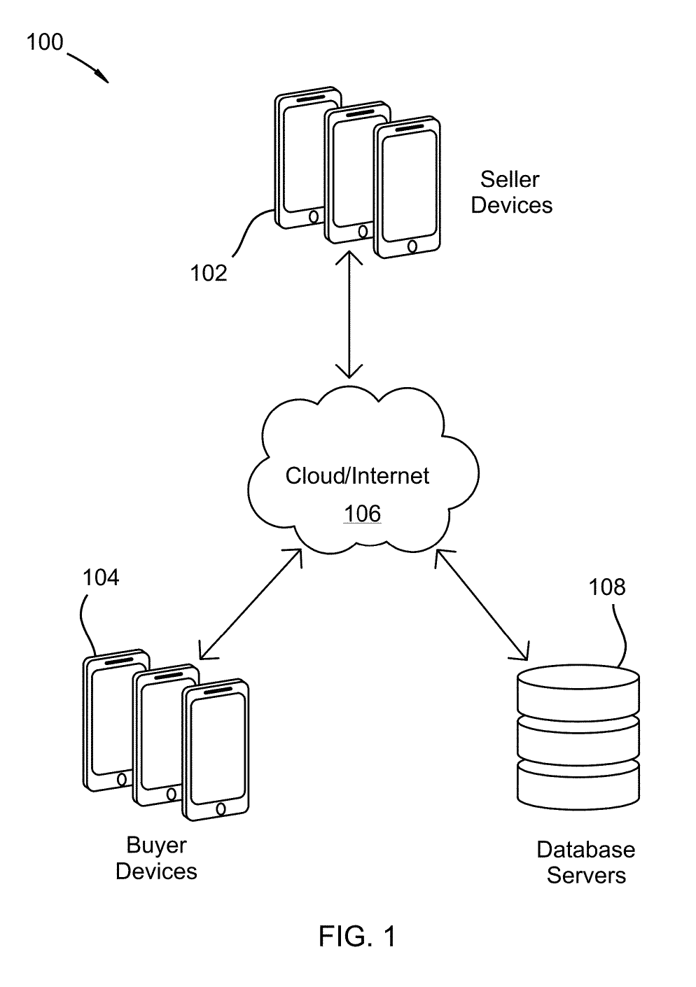

FIG. 1 shows a depiction of a raffle transaction system in accordance with an embodiment of the invention. The method of raffle transaction may be utilized in a system of raffle transaction 100 wherein an electronic server or database servers 108 are used to collect the data for transaction events. The cloud network or internet 106 may connect the data from the servers to the buyers and sellers through their electronic devices. Sellers may use electronic devices 102 to input information for a transaction item and transaction event. The buyer devices 104 may allow buyers to access transaction events and purchase one or more of a number of raffle slots. A buyer device 104 or a seller device 102 may be a smartphone, tablet, iPod, laptop, desktop, smart TV, etc. which may include an app, internet access, or other programming to allow access to the cloud network 106. The raffle transaction software 106/108 may include allowing a buyer and seller the ability to communicate, buy, sell, trade, barter, and raffle. The programming 106/108 may also include a safe and secure exchange of money and address information between buyers and sellers. One embodiment of the invention may include a seller choosing to sell a book for $10, with five raffle slots, at $2 for each raffle slot, and may set the time period of the transaction event for one day. Five different buyers may buy a raffle slot, or one buyer may buy most or all of the five raffle slots. At the end of the time period a random raffle slot may be selected to be the winning raffle slot and the buyer of the winning raffle slot will be awarded the book. The seller may receive the collected $10 or may be required to pay a commission. The buyer awarded the book may receive it only paying $2 or may have purchased all raffle slots and paid the full $10 to ensure receiving the book. If not all of the raffle slots have been sold by the end of the time period, the seller may be awarded the remaining raffle slots to have the chance of winning the transaction item back. The seller may also choose not to keep the remaining raffle slots to increase the chances of a buyer winning the transaction item. An embodiment of this would be if the seller selling a book for $10 with five raffle slots for $2 each, and only three raffle slots are sold by the end of the time period. The seller may receive the remaining two raffle slots, and if one of the two remaining raffle slots is selected to be the winning raffle slot, the seller would be awarded the book and $6 for the raffle slots sold. The seller may choose to not keep the two remaining raffle slots and instead increase the chances for the buyers of the three purchased raffle slots. The winning raffle slot may be selected from the three purchased raffle slots and the seller may receive $6 for the sold book.

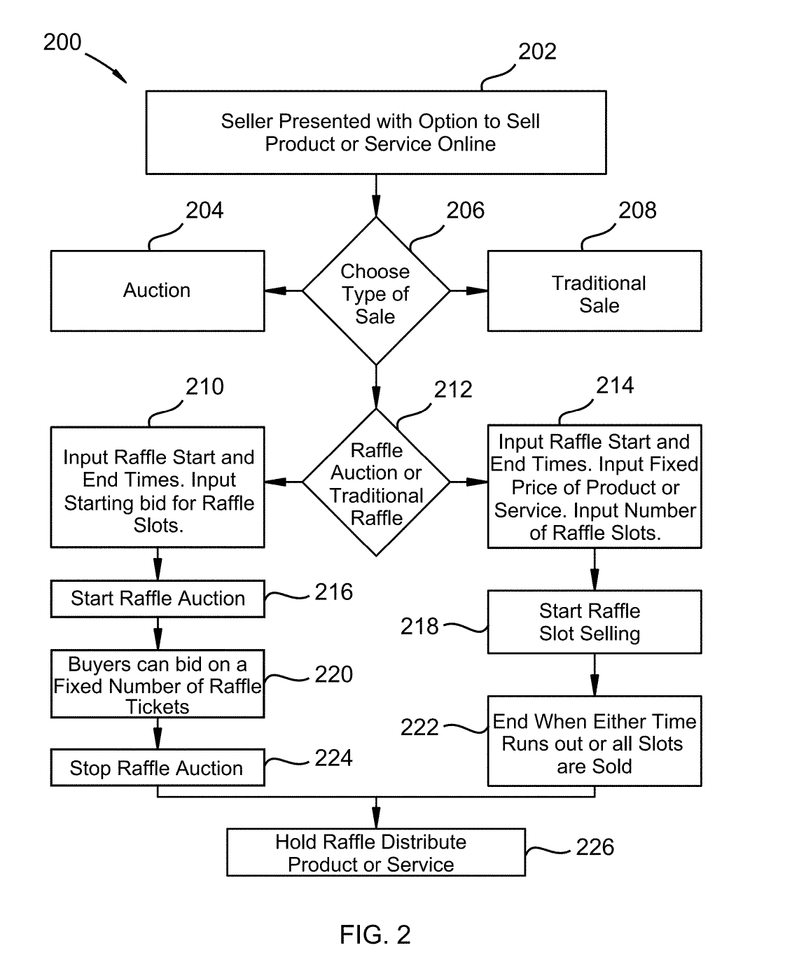

FIG. 2 shows a flow diagram of a raffle transaction event in accordance with an embodiment of the invention. The seller may open a raffle transaction app and have an option to sell a transaction item 202. The seller chooses the type of sell 206, between a direct purchasing or traditional sale 208 or a bidding process or auction sale 204. The seller may choose a hybrid 212 of the two and select a certain number or percentage of the raffle slots to be sold by direct purchasing or bidding process. In the case of a direct purchasing raffle transaction event, the seller may choose start and end times for the time period of the transaction event, the fixed price of the transaction item, and the number of raffle slots to sell 214. When using the bidding process, a seller may choose the time period for the transaction event, number of raffle slots, and a starting price for the bidding process raffle slots 210. The transaction event begins, and raffle slots are sold 218, or bided on 220. The time period will end, and the bidding process will end 224. With direct purchasing the transaction event may end before the time period if all of the raffle slots are sold 222. If there are remaining raffle slots at the end of the time period, the remaining raffle slots may be awarded to the seller. A random raffle slot may be selected to be the winning raffle slot and the transaction item may be awarded to the owner of the winning raffle slot 226. In an embodiment of the invention a seller may choose a hybrid transaction event 212 in which all of the direct purchasing raffle slots may be sold quickly and the seller may watch the price of the bidding process raffle slots increase as more buyers bid, until the end of the transaction event 224. The bidding process 220 may be a blind bid in which bidders only see if they are the highest bidder or not, or it may be an open bid in which all buyers are listed with their bid amount. An embodiment of the invention may include an automated bidding process for buyers to input their max amount and set the automation to raise the buyer's bid each time the buyer is out-bidden.

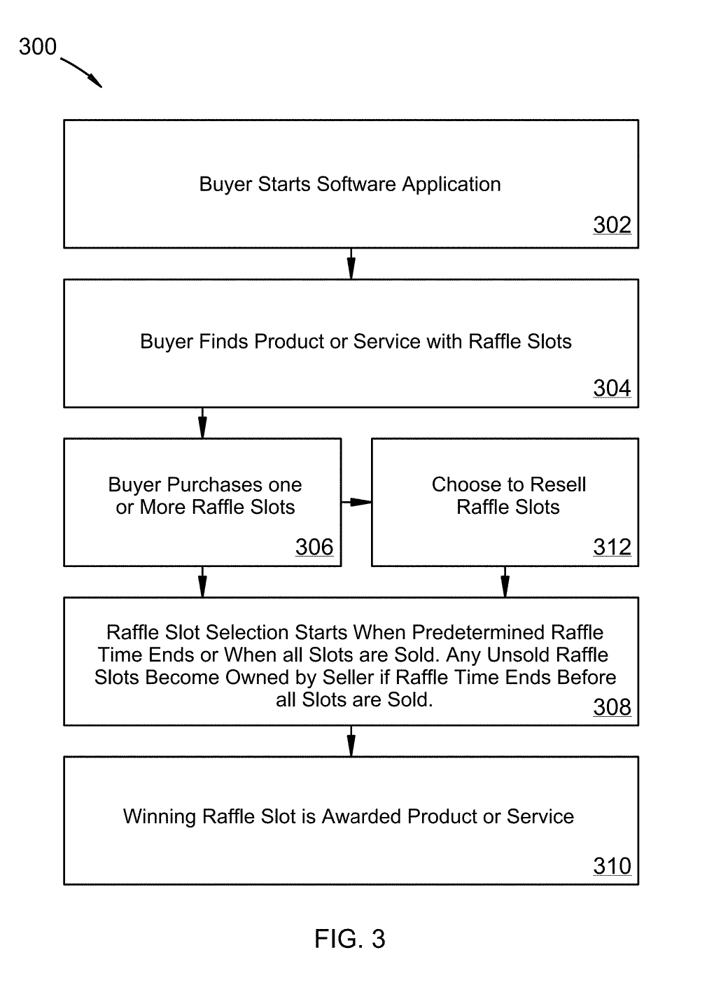

FIG. 3 shows a flow diagram of a buyer in accordance with an embodiment of the invention. A buyer may open a raffle transaction app or website 302 and find an interesting transaction item listed through the network 304. The buyer may purchase one or more of the number of raffle slots 306 through direct purchasing or a bidding process. A buyer may decide to become a reseller and resell the one or more of the number of purchased raffle slots for a higher price through direct purchasing or the bidding process 312 until the end of the time period. The time period ends, any unsold raffle slots may be awarded to the seller 308 and a randomly selected raffle slot may be awarded the transaction item 310. In an embodiment of the invention a buyer may find a desired transaction item 304 and buy one or more of the number of raffle slots 306 for $10 a piece. The buyer may decide not to keep all of the purchased one or more of the number of raffle slots and choose to resell the raffle slots 312 for $11 a piece or by a bidding process starting at $11 for each raffle slot. The reseller may resell all purchased raffle slots and no longer retain a chance of being awarded the transaction item but may receive money from the reselling of the raffle slots. Or the reseller may have kept one or more of the purchased raffle slots which may have been selected as the winning raffle slot so the reseller may be awarded the transaction item as well as the money earned for reselling one or more of the purchased raffle slots.

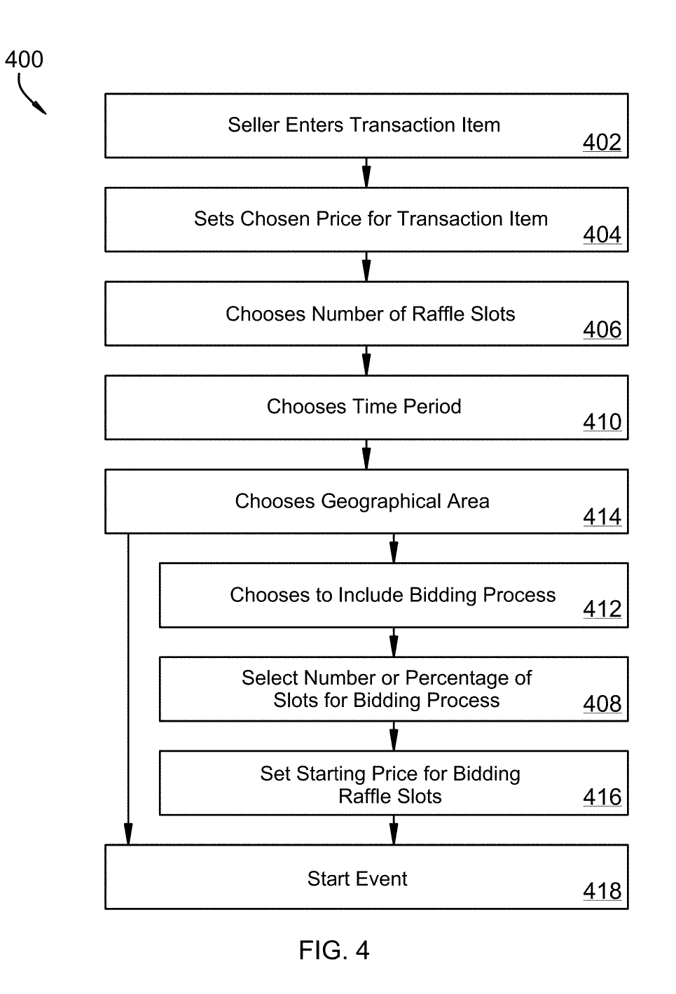

FIG. 4 shows a flow diagram of a setup process of a transaction event in accordance with an embodiment of the invention. As a seller opens the raffle transaction software, the seller may begin a transaction event by putting in a transaction item 412 which may be a product or service. The seller may set the chosen price for the transaction item 414 which may be the value of the transaction item or what the seller hopes to earn from the transaction event. The seller may choose the number of raffle slots to be sold 406 and the chosen price for the transaction item may be divided by the number of raffle slots to set the price of each raffle slot. The seller may choose the time period 410 for the transaction event as well as a geographical area 414. The seller may choose to include a bidding process in the selling of the number of raffle slots 412 in which the seller may choose a number of the number of raffle slots or a percentage of the total number of raffle slots to be sold in a bidding process, the seller may also choose the starting price of the bidding raffle slots. An embodiment of the invention may include a seller choosing to sell a service such as a season of lawn and yard care, in which case the option to select the geographical area 414 would be important. The seller of the lawn care service may select a number of the raffle slots to be sold using the bidding process 412 allowing the possibility of a greater payment for the service. All raffle slots being sold for the lawn care service may be sold by the bidding process and the seller may earn a significantly larger amount than the value of the service and the buyer of the winning raffle slot may receive the lawn care service by only paying for a portion of the value.

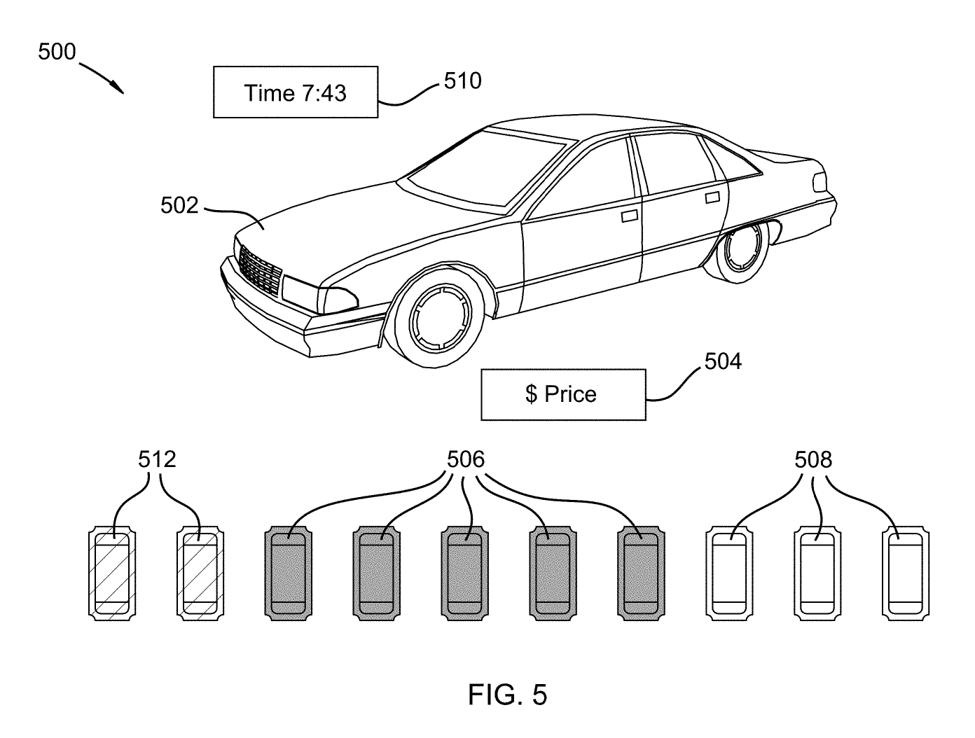

FIG. 5 shows a depiction of a transaction event in accordance with an embodiment of the invention. In an embodiment of the raffle transaction software display, a buyer may see the transaction item pictured 502, the time period of the event 510 and the price 504. The number of raffle slots 512, 506, and 508 may also be shown. A buyer may see available raffle slots 508 to purchase as well as how many raffle slots have already been purchased 506. The buyer may also see raffle slots made available by a reseller 512. In an embodiment of the invention the transaction item 502 may be a used car being sold for $500 (504) with ten raffle slots at $50 each. One buyer may have purchased seven of the raffle slots 512 and 506 and chosen to resell two of the purchased raffle slots 512. Another buyer may open the transaction event and choose to purchase one or more of the remaining raffle slots 508 or of the raffle slots available for resell 506. If no other buyer purchases the remaining raffle slots 508 or the raffle slots available for resell 506 by the end of the time period 510, they may be awarded to the seller or reseller respectively. In one embodiment, funds used to purchase raffle slots or electronic tickets may be escrowed in a holding account until all raffle slots or electronic tickets have been purchased. If all raffle slots or electronic tickets do not sell within a time limit, a seller may cancel the raffle sale or choose to self-purchase the remaining raffle slots or electronic tickets. When all raffle slot or electronic tickets have been accounted for the system may automatically generate a random winner of sale item or service.

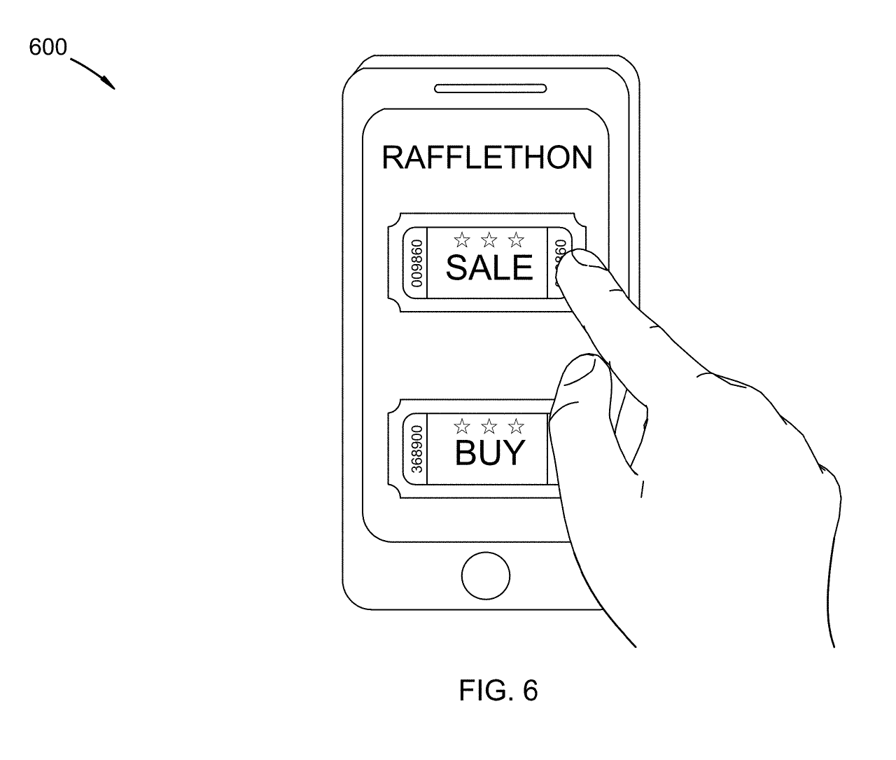

FIG. 6 shows an example of an electronic device 600 used to list an item for raffle sale or for buying a raffle slot or electronic raffle ticket. A raffle user may download raffle application software and either list items for raffle or purchase an opportunity to win a random electronic drawing.

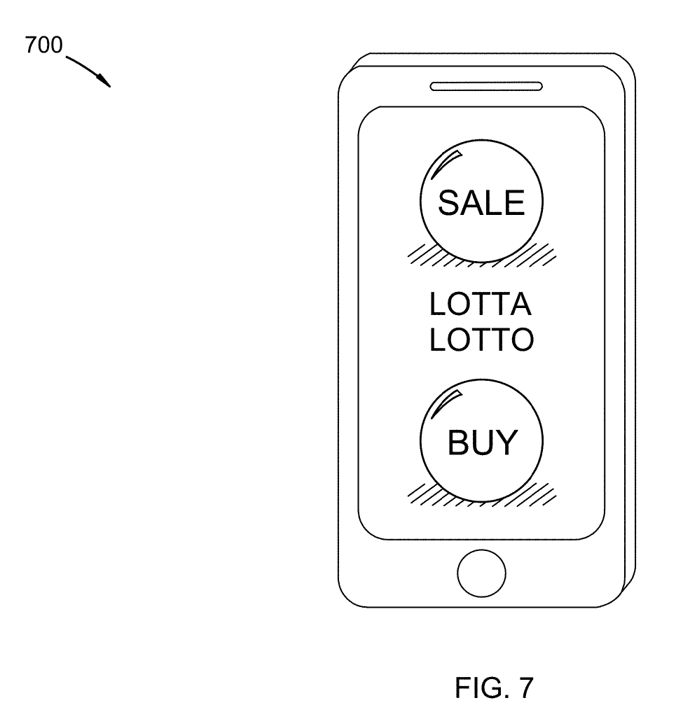

FIG. 7 shows an example of an electronic device 700 used to list an item for raffle sale or for buying a raffle slot or electronic raffle ticket. A raffle/lottery user may download raffle/lottery application software and either list items for a lotto drawing (raffle slot) or purchase an opportunity to win a random electronic drawing through an electronic random lottery drawing.

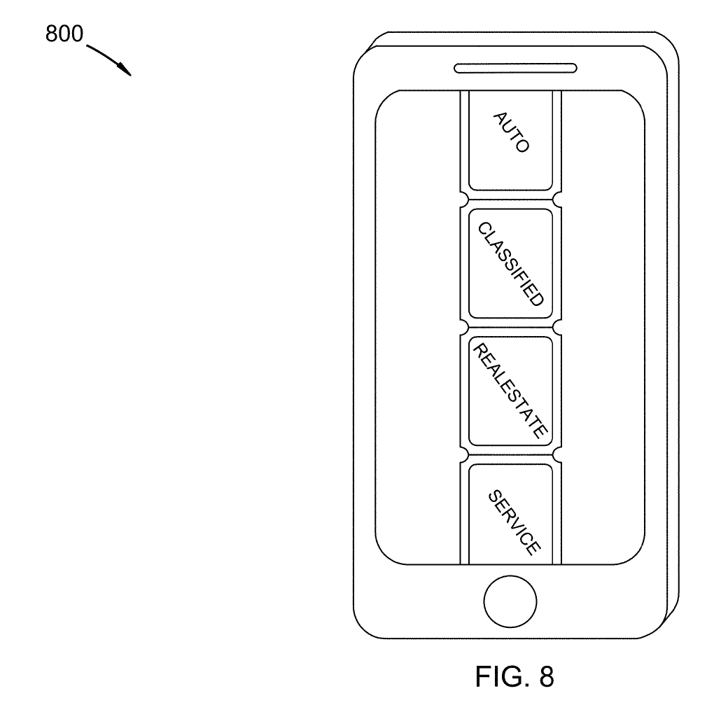

FIG. 8 shows an example of an electronic device 800 used to list an item for raffle sale or for buying a raffle slot or electronic raffle ticket. A raffle user may download raffle application software and either list items for raffle or purchase an opportunity to win a random electronic drawing. Product selections commonly found in an online sales site may be used with the raffle system and method as taught herein.

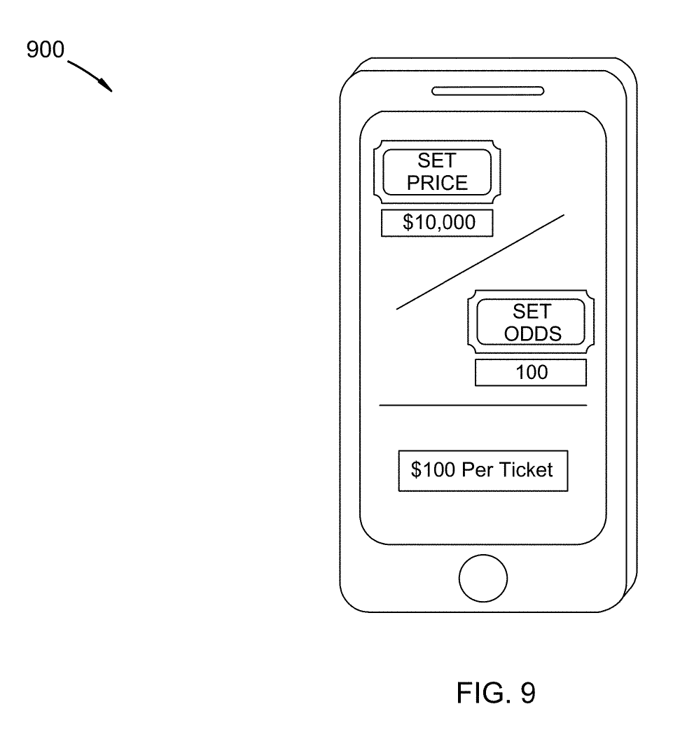

FIG. 9 shows an example of an electronic device 900 used to list an item for raffle sale or for buying a raffle slot or electronic raffle ticket. A raffle user may download raffle application software and either list items for raffle or purchase an opportunity to win a random electronic drawing. When a user lists a product of service for sale, a sales price may be entered, a number of raffle slots or odds of winning the product or service may be entered, and a price per raffle slot may be automatically determined by dividing the set price by the number of raffle slots/odds as shown in FIG. 9.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of raffle transaction comprising:
receiving, using an electronic server, data for a transaction event;
requiring a seller, through a cloud network, to add a transaction item, a number of raffle slots, a time period, and a price;
listing a transaction item through a network;
a buyer purchasing one or more of the number of raffle slots through an electronic device;
tracking purchases of the number of raffle slots sold during the time period;
awarding any remaining raffle slots to the seller at the end of the time period; and
randomly selecting a winning raffle slot and awarding the transaction item to the buyer of the winning raffle slot;
wherein the seller distributes the transaction item through the raffle transaction using the transaction event.

2. The method of claim 1, wherein the buyer of one or more of the number of raffle slots is permitted to become a reseller and resell one or more of the number of raffle slots purchased for a higher price before the time period expires, by selecting a resale option within the transaction event.

3. The method of claim 1, wherein the purchasing of the one or more of the number of raffle slots happens through a bidding process.

4. The method of claim 3, wherein the seller designates a number of the number of raffle slots for the bidding process.

5. The method of claim 3, wherein the seller chooses a combination of both the bidding process and direct purchasing in a hybrid raffle transaction form.

6. The method of claim 1, wherein the seller sets a chosen price for the transaction item and a price of a raffle slot is determined by the chosen price for the transaction item and the number of raffle slots chosen.

7. The method of claim 3, wherein the seller chooses a starting price of a bidding process raffle slot of the number of raffle slots.

8. The method of claim 5, wherein the seller selects a percentage of the number of raffle slots to be of a different raffle transaction form as the rest.

9. The method of claim 1, wherein the seller chooses a geographical area for the transaction event.

10. The method of claim 5, wherein the resale option allows the reseller to resell one or more of the number of raffle slots using the bidding process or the direct purchasing raffle transaction form until the time period chosen by the seller expires.

11. A system of raffle transaction comprising:
an electronic server that collects data for a transaction event;
a cloud network connecting the electronic server and the data for the transaction event to a seller through a seller's electronic device, and a buyer through a buyer's electronic device;
the system comprising a non-transitory computer program product programmed to:
receiving, using the electronic server, data for the transaction event;
requiring a seller, through the cloud network, to add a transaction item, a number of raffle slots, a time period, and a price;
listing a transaction item through a network;
a buyer purchasing one or more of the number of raffle slots through an electronic device;
tracking purchases of the number of raffle slots sold during the time period;
awarding any remaining raffle slots to the seller at the end of the time period; and
randomly selecting a winning raffle slot and awarding the transaction item to the buyer of the winning raffle slot;
wherein the seller distributes the transaction item through the raffle transaction using the transaction event.

12. The system of claim 11, wherein the buyer of one or more of the number of raffle slots is permitted to become a reseller and resell one or more of the number of raffle slots purchased for before the time period expires, by selecting a resale option within the transaction event.

13. The system of claim 11, wherein the purchasing of the one or more of the number of raffle slots happens through a bidding process.

14. The system of claim 13, wherein the seller designates a number of the number of raffle slots for the bidding process.

15. The system of claim 13, wherein the seller chooses a combination of both the bidding process and direct purchasing in a hybrid raffle transaction form.

16. The system of claim 11, wherein the seller sets a chosen price for the transaction item and a price of a raffle slot is determined by the chosen price for the transaction item and the number of raffle slots chosen.

17. The system of claim 13, wherein the seller chooses a starting price of a bidding process raffle slot.

18. The system of claim 15, wherein the seller selects a percentage of the number of raffle slots to be of a different raffle transaction form as the rest.

19. The system of claim 11, wherein the seller chooses a geographical area for the transaction event.

20. The system of claim 15, wherein the resale option allows the reseller to resell one or more of the number of raffle slots using the bidding process or the direct purchasing raffle transaction form until the time period chosen by the seller expires.
